(19) United States
(12) Patent Application Publication
(10) Pub. No.: US 2002/0132617 A1
(43) Pub. Date: Sep. 19, 2002

(54) Method and apparatus for providing virtual frequency identifiers for internet radio

(76) Inventors: Randall S. Nuss, Santa Cruz, CA (US); Robert S. Werbicki, Aptos, CA (US)

Correspondence Address: Daniel M. DeVos, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/755,931

(22) Filed: Jan. 5, 2001

(51) Int. Cl. H04Q 7/20

(52) U.S. Cl. 455/422

(57) ABSTRACT

A method and apparatus for providing virtual frequency identifiers for Internet radio. In one embodiment, a dedicated Internet radio device includes a display, memory, a selector, and a processor. The display displays a currently selected one of a number of virtual frequency identifiers in a fixed number of display positions. The memory has stored therein the virtual frequency identifiers. Each of the virtual frequency identifiers includes a fixed number of fields that encode with an integer value a different identifying attribute of Internet radio stations; however, the sizes of at least some of these fields vary between different ones of the virtual frequency identifiers. The processor is coupled to the display, the memory, and the selector to select different ones of the virtual frequency identifiers as the currently selected virtual frequency identifier.

### FIELD OF INVENTION

The present invention relates to the field of communications, and more particularly to internet audio communications.

### BACKGROUND OF THE INVENTION

For many years, audio communications have been broadcast almost instantly from a source to receivers via radio waves. These radio communications were limited in range and quality, not permitting distant high-quality audio communications. More recently, the Internet has become a vehicle for communicating audio signals over greater distances while maintaining high audio quality. General purpose computers running internet communications programs have been used to receive audio signals from sources sending such signals through the Internet. However, these general purpose computers continue to be expensive and less cost effective for those who would purchase such a computer solely or primarily for listening to internet radio. Furthermore, the complexity of using such computers continues to deter those who prefer the simpler interface of a conventional radio. Some lower cost dedicated internet audio devices do now exist, some even having the appearance of a conventional radio. Even so, the complexity of operating these devices persists.

### SUMMARY OF THE INVENTION

A method and apparatus for providing virtual frequency identifiers for Internet radio is described. In one embodiment, a dedicated Internet radio device includes a display, memory, a selector, and a processor. The display displays a currently selected one of a number of virtual frequency identifiers in a fixed number of display positions. The memory has stored therein the virtual frequency identifiers. Each of the virtual frequency identifiers includes a fixed number of fields that encode with an integer value a different identifying attribute of Internet radio stations; however, the sizes of at least some of these fields vary between different ones of the virtual frequency identifiers. The processor is coupled to the display, the memory, and the selector to select different ones of the virtual frequency identifiers as the currently selected virtual frequency identifier.

### BRIEF DESCRIPTION OF THE DRAWINGS

The present invention is illustrated by way of example and not limitation in the figures of the accompanying drawings, in which like references indicate similar elements, and in which:

FIG. 1 is a flow diagram illustrating a method for an internet radio to play audio based on a selected identifier according to one embodiment of the invention.

FIG. 2 is a data flow diagram illustrating a method of transferring information so that an internet radio plays audio based on a selected identifier according to one embodiment of the invention.

FIG. 3 shows the components of an internet radio apparatus which plays audio based on a selected identifier according to one embodiment of the invention.

FIG. 4 is a table illustrating the different combinations of field sizes for virtual frequency identifiers according to one exemplary embodiment of the invention.

FIG. 5 is a table illustrating exemplary format code assignments according to one embodiment of the invention.

FIGS. 6A-6C illustrate exemplary displays with different stations selected according to one embodiment of the invention.

FIGS. 7A-7R illustrate exemplary contents of the display in normal mode according to one embodiment of the invention.

FIGS. 8A-8F illustrate exemplary contents of the display in setup mode.

### DETAILED DESCRIPTION

In the following description, for purposes of explanation, numerous specific details are set forth in order to provide a thorough understanding of the present invention. It will be evident, however, to one skilled in the art that the present invention may be practiced without these specific details.

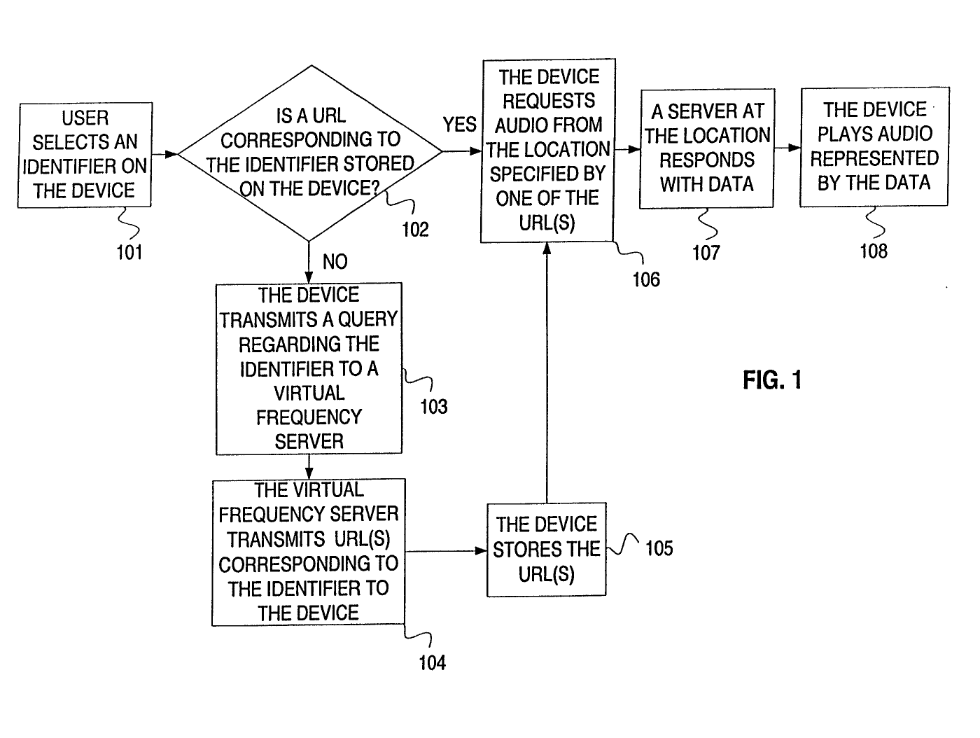

FIG. 1 is a flow diagram illustrating a method for an internet radio to play audio based on a selected identifier according to one embodiment of the invention. Internet radio is defined herein both as audio transmitted over the Internet, that audio being of similar quality to audio transmitted over radio waves, and as a device which plays such audio. A user of the internet radio device selects an identifier on the device, block 101. The identifier is selected from among a list of identifiers, such as a list of integers. The device displays the selected identifier. Other unselected identifiers are not displayed. This manner of display is simple, relatively inexpensive, and familiar to users of conventional non-internet radios. In one embodiment, the identifier is selected by using a control similar to that found on existing radios. For example, the identifier may be selected by turning a knob on the device, causing the identifier to increment or decrement depending on whether the knob is turned clockwise or counterclockwise. As another example, the identifier may be selected by pushing one button on the device, causing the identifier to increment, and pushing of another button on the device, causing the identifier to decrement. These manners of selection are simple and familiar to users of conventional radios, requiring little time and attention, advantageous to users of the device who are simultaneously occupied with other tasks, such as driving a car. In one embodiment, the identifier consists of 4 characters, resembling a conventional radio station identifier, furthering the familiarity and simplicity of selection. In another embodiment, the identifier consists of 6 characters. In yet another embodiment, the identifier consists of at most 8 characters. In any of these embodiments, the identifier may be an integer, or may include alphanumeric characters.

Once an identifier has been selected, the device determines whether it has stored in a mapping table a URL corresponding to the identifier, block 102. If such a URL is so stored, then the device proceeds to transmit over the Internet a request for audio from the remote internet location specified by the URL, block 106. An internet server at the location responds over the Internet with data appropriate to the request, block 107. This data represents audio. The device, upon receiving the data in response to the earlier request, plays the audio represented by the data, block 108.

If, in the process described above, the device determines that it has not stored in a mapping table a URL corresponding to the selected identifier, block 102, then the device must obtain the URL from a virtual frequency server. If the mapping table is full, then the device flushes out mappings from the table as needed according to some algorithm (for example, flushing the least frequently accessed mapping, flushing the least recently accessed mapping, etc.). The device transmits a query regarding the identifier over the internet to an virtual frequency server, block 103. The transmission of the query includes the transmission of the identifier. In one embodiment, the transmission of the query includes the transmission of data about internet connection speed (that is, the speed at which the device is able to transmit and receive data over the internet), data about audio encoding format (that is, the types and versions of players that the device may use to translate received data into audio), and a serial number which uniquely identifies the device and validates its request. Because internet radio may be encoded differently suitable to different connection speeds, each encoding at a different URL and all such URLs corresponding to a single identifier, data about internet connection speed advantageously allows the virtual frequency server to determine the URL most appropriate for the speed provided, or if no appropriate URL exists at all. Because internet radio may be encoded differently suitable to a variety of proprietary streaming audio players (for example, RealPlayer® computer software, etc.) and a variety of versions of such players, each encoding at a different URL and all such URLs corresponding to a single identifier, data about audio encoding format advantageously allows the virtual frequency server to determine if a device can properly interpret the format of data at a URL, and either transmit a proper player to the device (if required) or select a URL suitable for a player stored within the device. Accordingly, in one embodiment, this data about format may include a plurality of players stored within the device. The serial number advantageously allows the tracking and analysis of requests from specific devices, and prevents the unauthorized use of services by devices without a valid serial number. In alternative embodiments, the transmission of the query includes subsets of the data described above.

The virtual frequency server maintains a table mapping identifiers to one or more URLs, the URLs differing to allow for variance in connection speed and audio encoding format. In one embodiment, the virtual frequency server also stores streaming audio players for transmission to internet radio devices lacking such players. Streaming audio players are defined herein as audio software decoding modules. In the event that the device transmits a query to the virtual frequency server as described above, the virtual frequency server receives the request, including the identifier, and transmits a URL corresponding to the identifier over the Internet to the device, block 104. In one embodiment, the virtual frequency server receives data about connection speed, data about audio encoding format, and a serial number, all as explained above, and transmits a URL suitable for the connection speed and one or more URLs suitable for the audio encoding format. In one embodiment in which the virtual frequency server receives a serial number, the server transmits URLs only if the serial number is valid, advantageously preventing the unauthorized use of services. In alternative embodiments, the virtual frequency server receives and transmits subsets of the data described above. The virtual frequency server may also transmit a streaming audio player if an internet radio device lacks such a player required to translate data from a transmitted URL.

In one embodiment, instructions for the operations described above are provided by a machine-readable medium. A machine-readable medium includes any mechanism that provides (that is, stores and/or transmits) information in a form readable by a machine (for example, a computer). For example, a machine-readable medium includes read only memory (ROM); random access memory (RAM); magnetic disk storage media; optical storage media; flash memory devices; electrical, optical, acoustical or other form of propagated signals (for example, carrier waves, infrared signals, digital signals, etc.); etc.

The device receives from the virtual frequency server one of more URLs corresponding to the identifier and stores in a table the mapping of the identifier to the corresponding URL(s), block 105. This storage advantageously allows the device to receive future internet radio from those URL(s) without repeating blocks 103 through 105, as the mapping will be determined in block 102 as described above. Once the device has stored the URL(s), it proceeds with blocks 106 through 108, all as described above.

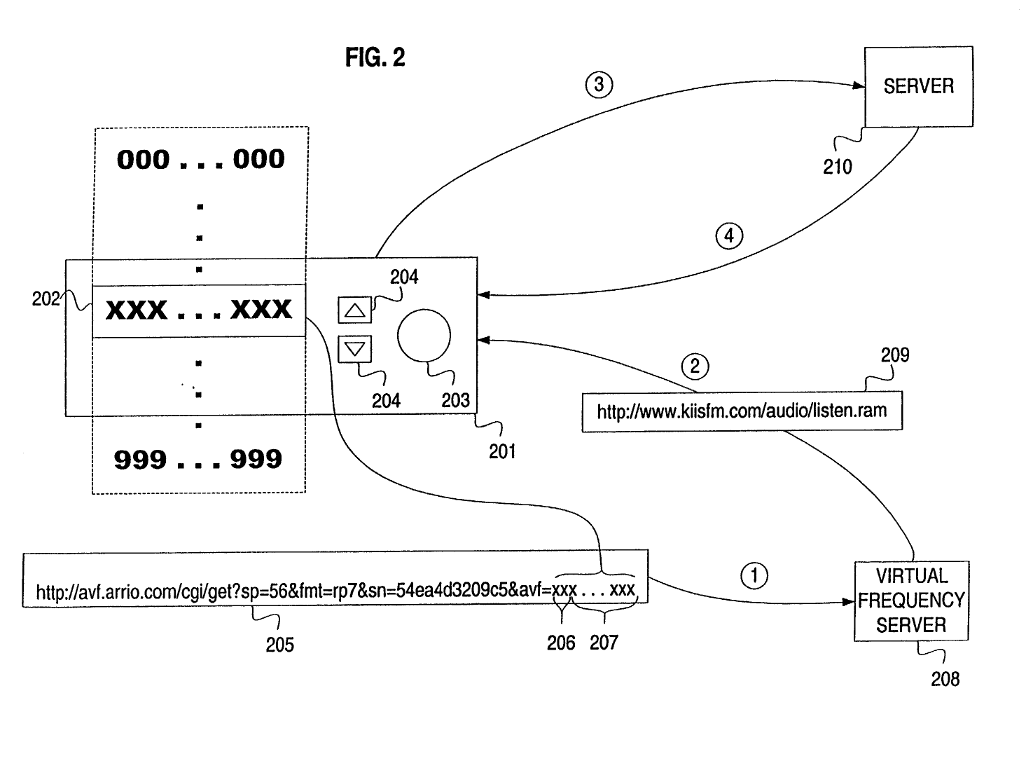

FIG. 2 is a data flow diagram illustrating a method of transferring information so that an internet radio plays audio based on a selected identifier according to one embodiment of the invention. An internet radio device 201 having a display 202 and a selector such as a knob 203 or set of buttons 204 allows a user to select a displayed identifier from among a list of undisplayed identifiers. This selection corresponds to block 101 of FIG. 1. If no mapping of identifier to URL(s) is stored in the device, the selected identifier is encoded in an HTTP request 205 addressed to the virtual frequency server 208. The request includes the identifier, which is also called the virtual frequency identifier. In one embodiment, the identifier includes a region code 206 and a station code 207. The station code 207 is designed to emulate a radio station identifier on a conventional radio, advantageously providing familiarity and simplicity in selection. Since a station code 207 in one geographical area might be identical to a station code 207 in another geographical area, the region code 206 advantageously distinguishes between otherwise identical station codes from different geographical areas, and further enables a user to more easily select station codes from geographical locations of most interest. As described above and shown in FIG. 2, the request 205 may also have encoded within it data about connection speed (for example, “sp=56”), audio encoding format(s) (for example, “fmt=rp7”), and serial number (for example, “sn=54ea4d3209c5”). The request 205 is transmitted over the Internet to the virtual frequency server 208 as shown by circle 1. This transmission corresponds to block 103 of FIG. 1. The virtual frequency server 208 then transmits over the Internet one or more appropriate URLs 209 corresponding to the identifier 205 to the internet radio device 201 as shown by circle 2. This transmission corresponds to block 104 of FIG. 1.

The internet radio device 201, having the URL(s) 209 from either local storage or from the virtual frequency server 208, then transmits over the Internet a request for audio from the location specified by one such URL 209 as shown by circle 3. This transmission corresponds to block 106 of FIG. 1. A server 210 at the location responds over the Internet to the device 201 with data representing audio as shown by circle 4. This response corresponds to block 107 of FIG. 1. The device 201 then plays the audio represented by the data, as described in block 108 of FIG. 1.

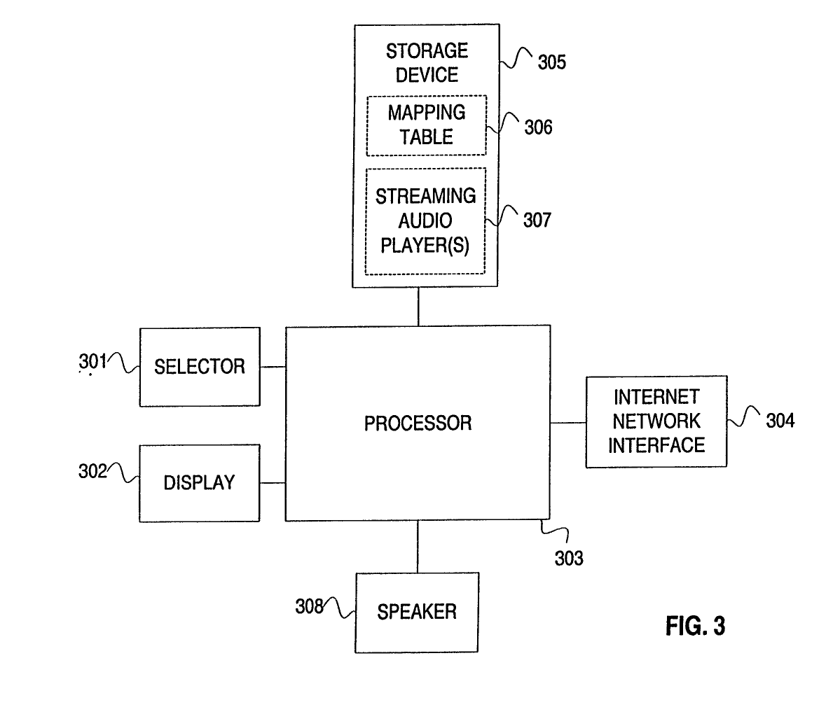

FIG. 3 shows the components of an internet radio apparatus which plays audio based on a selected identifier according to one embodiment of the invention. The device comprises a processor 303 for calculating logical operations and for routing signals to and from components coupled to it. One such component coupled to the processor 303 is a display 302 to show one internet radio selection from among a undisplayed list of internet radio selections. The display 302 is a non-graphical alphanumeric display (for example, a vacuum fluorescent display, a liquid crystal display, an electrophoretic display, etc.) advantageously decreasing the cost of manufacturing the device and further permitting integration of the device into other electronics. Also coupled to the processor 303 is a selector 301 which may, as described above, be a knob and/or a set of buttons. The selector 301 drives the display 302 to display an identifier chosen via the selector 301 from among an undisplayed list of identifiers. Also coupled to the processor 303 is an internet network interface 304 (for example, a modem or Ethernet card or wireless internet interface) to transmit and receive data via the Internet. Also coupled to the processor 303 is a storage device 305 (for example, nonvolatile memory and/or magnetic media) to store one of more streaming audio players 307 (for example, RealPlayer® computer software, etc.), and a table 306 of one or more mappings of identifiers to URLs. Also coupled to the processor is a speaker 308 to emit audio represented by data received through the internet network interface 304.

While all of the components described above may be contained in an independent device, one or more components may also be integrated into other devices already having parts (for example, a display 301, a selector 302, and a speaker 308) which are capable of transmitting signals to and receiving signals from such integrated components. Such potential for integration advantageously provides manufacturers with the ability to easily add Internet radio functionality to other electronics, saving the time and cost of manufacturing the Internet radio components themselves. For example, a conventional non-internet radio that includes a vacuum fluorescent display or liquid crystal display may be modified to support Internet radio as well using the same display. Accordingly, in one embodiment, the processor 303, internet network interface 304, and storage device 305 or subsets thereof are consolidated on one electronic chip having interfaces convenient to other components external to the electronic chip.

Additional Embodiments of the Invention

In certain alternative embodiments of the invention, rather than performing a query to a server when a mapping for a virtual frequency identifier is not present in the Internet radio device's mapping table, no such query is performed. In certain of these embodiments in which no such query is performed, the device periodically receives (responsive to a request from the device) an update to its current mapping table from the server (each internet radio device can be sold with a mapping table stored in flash memory; such updates can be an entire mapping table or a delta from its previously stored table). Also, in certain of these embodiments in which no such query is performed, the virtual frequency identifiers for which no mappings are currently available are automatically skipped when operating the virtual frequency identifier selection mechanism.

Independent of how the mapping table is maintained, certain embodiments implement the virtual frequency identifiers as having different fields, each field encoding a different identifying attribute of internet radio stations. In addition, although the fields can vary in size for different ones of the virtual frequency identifiers, each of the virtual frequency identifiers can be displayed within the same number of digits.

FIG. 4 is a table illustrating the different combinations of field sizes for virtual frequency identifiers according to one exemplary embodiment of the invention. In this exemplary embodiment, three fields respectively store a region code, a format code, and a station code. In addition, in this exemplary embodiment, the sum total of the number of digits in these three fields for every virtual frequency identifier is six digits, but the number of digits allocated a given one of the fields varies. While this exemplary embodiment is described below with respect to six digit, three field virtual frequency identifiers that can be displayed in a fixed number of display positions, alternative embodiments could use a different number of digits, a different number of fields, and/or different fields.

As illustrated in FIG. 4, the region code is a one to three digit number that identifies the location of the audio source stream. In one embodiment, the region code is based on the country code prefix of the established international, long distance phone system. See Table 1. In one embodiment, the other unused region numbers are reserved for private, special, or pay-per-listen transmissions.

TABLE 1

| Region | Region Code |
|---|---|
| United States | 1 |
| Canada | 28 |
| Caribbean | 8 |
| Egypt | 20 |
| South Africa | 27 |
| Greece | 30 |
| Netherlands | 31 |
| Belgium | 32 |
| France | 33 |
| Spain | 34 |
| Hungary | 36 |
| Italy | 39 |
| Romania | 40 |
| Switzerland, | 41 |
| Liechtenstein | |
| Austria | 43 |
| United Kingdom | 44 |
| Denmark | 45 |
| Sweden | 46 |
| Norway | 47 |
| Poland | 48 |
| Germany | 49 |
| Peru | 51 |
| Mexico | 52 |
| Cuba, Guantanamo Bay | 53 |
| Argentina | 54 |
| Brazil | 55 |
| Chile | 56 |
| Columbia | 57 |
| Venezuela | 58 |
| Malaysia | 60 |
| Australia | 61 |
| Indonesia | 62 |
| Philippines | 63 |
| New Zealand | 64 |
| Singapore | 65 |
| Thailand | 66 |
| Russia | 70 |
| Japan | 81 |
| Korea | 82 |
| Vietnam | 84 |
| China | 86 |
| Turkey | 90 |
| India | 91 |
| Pakistan | 92 |
| Sri Lanka | 94 |
| Myanmar | 95 |
| Iran | 98 |
| Morocco | 212 |
| Algeria | 213 |
| Tunisia | 216 |
| Libya | 218 |
| Senegal | 221 |
| Ivory Coast | 225 |
| Benin | 229 |
| Liberia | 231 |
| Ghana | 233 |
| Nigeria | 234 |
| Central African | 236 |
| Republic | |
| Cameroon | 237 |
| Congo | 242 |
| Zaire | 243 |
| Angola | 244 |
| Ethiopia | 251 |
| Kenya | 254 |
| Tanzania | 255 |
| Uganda | 256 |
| Burundi | 257 |
| Mozambique | 258 |
| Zambia | 260 |
| Zimbabwe | 263 |
| Namibia | 264 |
| Malawi | 265 |
| Botswana | 267 |
| Eritrea | 291 |
| Aruba | 297 |
| Greenland | 299 |
| Gibraltar | 350 |
| Portugal | 351 |
| Luxembourg | 352 |
| Ireland | 353 |
| Iceland | 354 |
| Albania | 355 |
| Malta | 356 |
| Cyprus | 357 |
| Finland | 358 |
| Bulgaria | 359 |
| Lithuania | 370 |
| Latvia | 371 |
| Estonia | 372 |
| Armenia | 374 |
| Belarus | 375 |
| Monaco | 377 |
| Vatican City | 379 |
| Ukraine | 380 |
| Yugoslavia | 381 |
| Croatia | 385 |
| Bosnia, Herzegovina | 387 |
| Macedonia | 389 |
| Czech Republic | 420 |
| Slovakia | 421 |
| Belize | 501 |
| Guatemala | 502 |
| El Salvador | 503 |
| Honduras | 504 |
| Nicaragua | 505 |
| Costa Rica | 506 |
| Panama | 507 |
| Haiti | 509 |
| Bolivia | 591 |
| Guyana | 592 |
| Ecuador | 593 |
| Paraguay | 595 |
| French Antilles | 596 |
| Suriname | 597 |
| Uruguay | 598 |
| Netherlands Antilles | 599 |
| Guam | 671 |
| Fiji | 679 |
| French Polynesia | 689 |
| Hong Kong | 852 |
| Macao | 853 |
| Cambodia | 855 |
| Laos | 856 |
| Bangladesh | 880 |
| Taiwan | 886 |
| Lebanon | 961 |
| Jordan | 962 |
| Syria | 963 |
| Iraq | 964 |
| Kuwait | 965 |
| Saudi Arabia | 966 |
| Yemen | 967 |
| Oman | 968 |
| United Arab Emirates | 971 |
| Israel | 972 |
| Bahrain | 973 |
| Qatar | 974 |
| Mongolia | 976 |
| Nepal | 977 |
| Azerbaijan | 994 |
| Georgia | 995 |

As shown in the example of FIG. 4, a single-digit number is allocated to encode different formats or genres. FIG. 5 is a table illustrating exemplary format code assignments according to one embodiment of the invention. Alternative embodiments of the invention could use more digits, different categories, and/or sub-formats as illustrated in FIG. 5. In one embodiment, countries with 25 or fewer stations are aggregated under Format 0 regardless of actual format.

The station code along with the region code and the format code represents the audio source stream. In this manner, the station code field encodes different audio source streams within each of the different geographic regions and station formats identified by the other two fields. As illustrated in example of FIG. 4, the station code is the last two to four digits depending on how many digits are used for the region code. In this exemplary embodiment, the region code drives the size of the station code. Thus, although the size of the fields may vary between different virtual frequency identifiers, the contents of the fields for every one of the virtual frequency identifiers collectively fit within the same number of positions (can be individually displayed within the same number of integer digits). In alternative embodiments, the number of digits for different ones of the virtual frequency identifiers can be of different.

The virtual frequency identifiers provide a unique channel number to each audio source stream (e.g., internet radio station) in the mapping table. Using this numbering system, internet radio stations can be easily identified in a numerical system that is language independent. Furthermore, the use of this numbering system allows the use of low-cost displays on next-generation consumer multimedia equipment. While this numbering scheme is described with respect to a dedicated Internet radio device, it is understood that it could be used in other devices.

As described below, in certain embodiments each field of the currently displayed virtual frequency identifier is independently changeable to select different ones of the virtual frequency identifiers as the currently displayed virtual frequency identifier. However, alternative embodiments change the currently display virtual frequency identifier as a whole or treat some subset(s) of the fields as a whole.

In one embodiment in which the six digit, three field virtual frequency identifiers described above with respect to FIGS. 4-5 are used, the display consists of a 2 line by 20 character alphanumeric display. In normal operation, the currently selected virtual frequency identifier is displayed on the top line of the display and various pieces of information are displayed on the second line (e.g., song title, artist name, station information, connection rate, sampling frequency, buffer status, etc.).

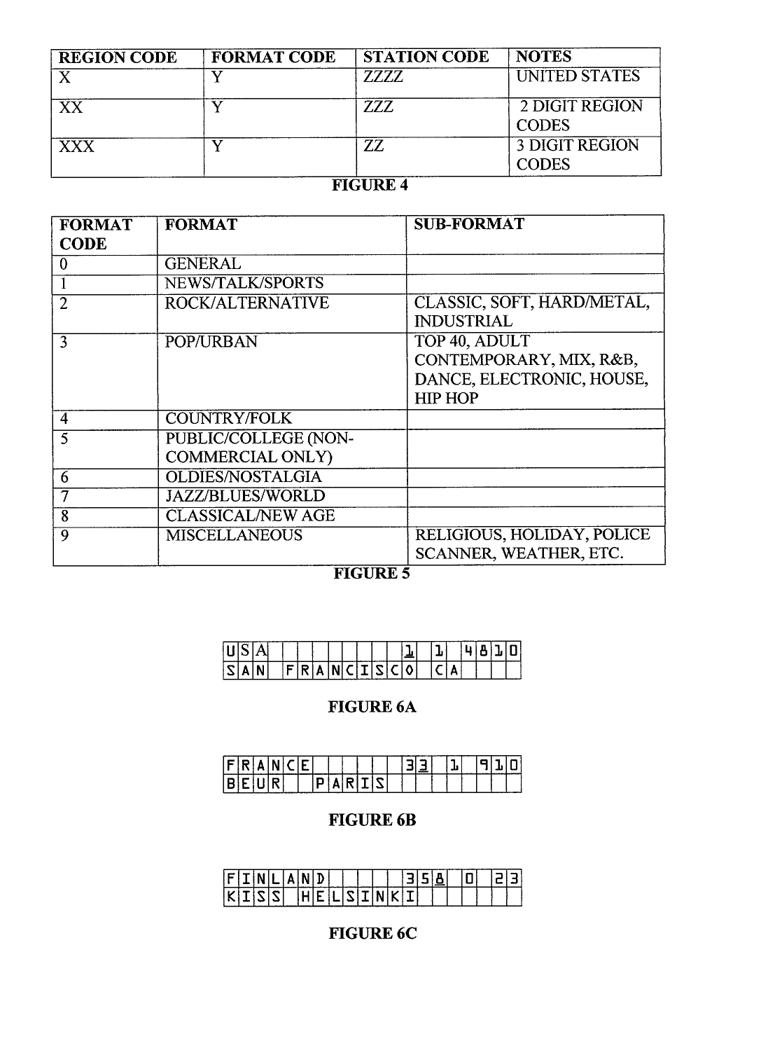

FIGS. 6A-6C illustrate exemplary displays with different stations selected according to one embodiment of the invention. In one embodiment, the Internet radio device has a normal mode (radio mode) and a setup mode as described later herein. FIGS. 6A-6C are exemplary displays while in the normal mode. Note that in FIGS. 6A-6C the justification of characters on the first line is: 1) alpha character information on the left hand side is left justified; and 2) the virtual frequency identifier is right justified—6 characters plus 2 spaces (8 total). No truncation should be necessary on the first line. In addition, all information on line 2 (lower line) is LEFT justified. Truncation may occur in some cases. In these cases, the last information characters are truncated.

In one embodiment, several controls (the selector) are provided to the user including a rotary tuning knob with an integral pushbutton and several pushbutton switches. Both tuning and setup can be accomplished by manipulation of these input controls.

Specifically, the knob provides a mechanism to select many items from a menu, incrementing or decrementing an integer value or selecting a particular letter in a character position. The rotary tuning knob with pushbutton can be used for a variety of functions as described later herein below.

A summary of the pushbutton controls is as follows:

| | | | | | | |
|---|---|---|---|---|---|---|
| 1 | 2 | 3 | 4 | 5 | Scan | Band |
| | | | | Scroll | Enter | Select |
| | | | | | | Setup |

The Setup pushbutton provides a mechanism to enter or exit the setup mode. In setup mode, various operational parameters can be displayed or modified as described later herein. The band pushbutton selects between AM, FM and Internet radio bands.

The buttons numbered 1-5 are station presets in normal mode. When you press Select in normal mode, then the preset buttons provide the lower row functions, such as scroll and enter.

The scroll pushbutton—(press Select to activate) changes the output of the second line display when pressed so that all display parameters from first, the database of radio stations, and second, the Internet media stream are displayed in order of hierarchy. An example of such information is shown in Table 2.

TABLE 2

| Information | Source |
|---|---|
| Station Location Name | From the Internet Radio Device |
| | (e.g., the mapping table) |
| Station Description | From the Internet Radio Device |
| Connection Speed | From the data stream |
| Artist Name | From the data stream |
| Song Title | From the data stream |
| Other Information | From the data stream |

The Scroll button will initiate the start of an automatic sequential scroll for 2 seconds per line through the above lines. When the information available has all been displayed, the display will return to the first line, which will normally be the Location of the station. If you press Scroll before the 2 seconds has elapsed the display will move to the next line of the scroll.

If you press Scroll and hold it down for 3 seconds or more, it will infinitely scroll until it is pressed again, in which case the scroll mode is cancelled and the display moves back to the prior or original massage of line 2.

Enter—This button is used in the Setup mode. When it is pressed the data that has been created for entry is entered.

Scan—When in normal (radio) mode this button will Scan to the next radio station similar to the Scan feature in a car radio. In one embodiment, the scan play time is approximately 5 seconds. To stop the Scan, you can either: 1) press Scan again—in which case the device will remain on the current station, or; 2) press in or turn the rotary tuning knob.

In the event that a one line only display is used, then the Select button will transfer the information that would normally be on the second line to the single line. Pressing select again will restore the display output to line 1 again.

While various controls and a display have been described for an exemplary embodiment, it is understood that any number of different controls and display configurations are within the scope of the invention.

Having described the controls, an exemplary implementation of the normal mode will be described with reference to the embodiments described with respect to FIGS. 4-6 above. Within the normal mode, there are two sub-modes: 1) a tuning mode; and 2) a listening mode.

In the tuning mode, the radio can be tuned by manipulating the rotary tuning knob to change the currently selected virtual frequency identifier. In one embodiment, depressing the knob will toggle among, from left to right: the Region Code, the Format Code, and the Station Code 1's digit, respectively.

In one embodiment, the rotary tuning knob is implemented to increment or decrement the integer fields of the virtual frequency identifiers taking angular velocity into account providing a pleasant feel and allowing rapid tuning changes with a minimum of revolutions. One way this can be accomplished is to determine the amount of time between successive positions of the control and determine a scaling factor to add or subtract to the current integer value. If the knob is rotating rapidly, the increment or decrement value could be 10 or even 100.

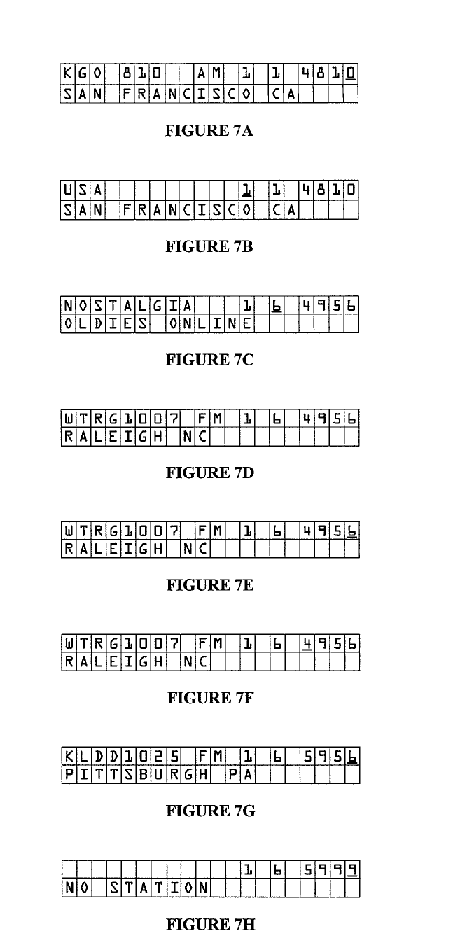

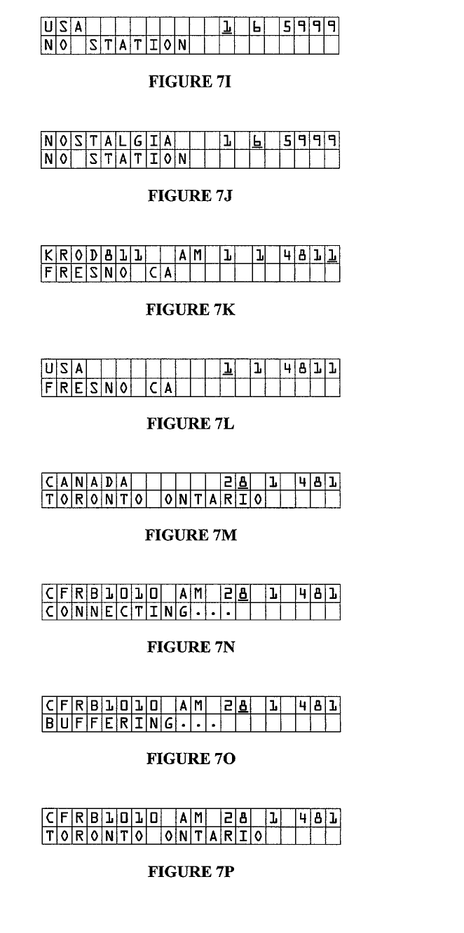

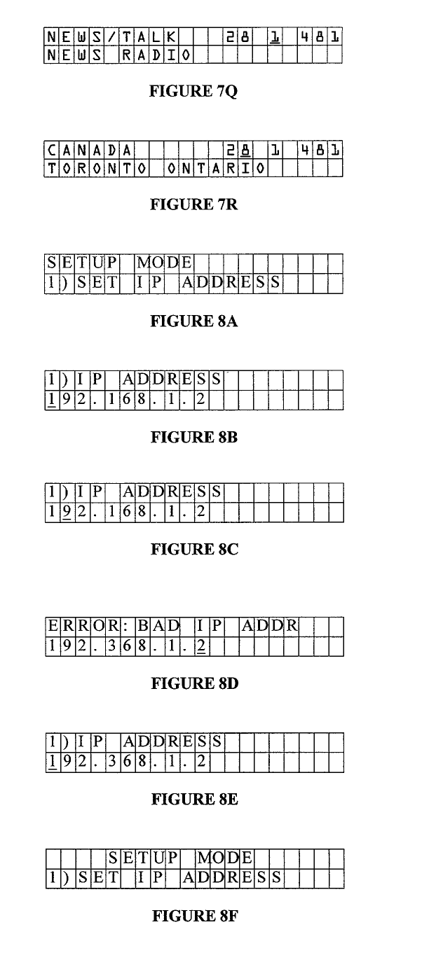

FIGS. 7A-7H illustrate exemplary contents of the display in normal mode according to one embodiment of the invention. In these figures, an underscore is used to indicate a display position and/or field of the currently virtual frequency identifier that is currently selected for changing. Such an underscore is present in the tuning mode, but not the listening mode. Alternative embodiments could use other techniques, including flashing, brightening/dimming, color change, etc.

During normal operation for a region like the USA with more than 24 stations, the current 6 digit virtual frequency identifier appears in the top line. In FIG. 7A, the cursor is shown in the ones digit of the station code. Note that the left side of the first display line displays radio station identification information (e.g., the call letters, frequency and/or band) of the currently selected audio source stream. Note that the ration station identification information is also stored in the mapping table along with the corresponding virtual frequency identifier and URL. Note also that the second line displays the station location name.

In FIG. 7B, the cursor is shown in the region code field. Note that while the second line still displays the station location, the left side of the first line now displays the region name assigned the currently selected region code.

In FIG. 7C, the cursor is shown in the format code field and the station number has been changed. Note that the left side of the first line now displays the name assigned the current format code, while the second line displays a station description. The station description is a value also placed in the mapping table. While the station description can be anything, it is typically text taken from how the radio station describes itself.

If the radio station is left for a predetermined amount of time (e.g., 3 seconds) with the cursor showing (in tuning mode), the radio will revert to the listening mode as illustrated in FIG. 7D.

Whether or not the radio station is left as described above, if the knob is depressed again the cursor is moved to the ones digit of the station code field (see FIG. 7E).

In one embodiment, if the rotation knob is held down while in the state shown in FIG. 7E, the cursor will move to the highest digit of the station code field as shown in FIG. 7F. This allows for rapid advancement of the tuning function. If the knob is turned to increment while held down in the state shown in FIG. 7F, the contents will change as shown in FIG. 7G. When the knob is released while in the state shown in FIG. 7F, the cursor returns to the ones digit.

In an embodiment that does not query a server when a virtual frequency identifier is being selected for which there is no station stored in the mapping table, the display may appear as shown in FIGS. 7H-7J according to one embodiment of the invention. In particular, FIGS. 7H-J respectively illustrate an exemplary display when the cursor is on the station code field, region code field, and format code field.

FIG. 7K illustrates an exemplary display when the rotation knob is rotated clockwise one detent from its state in FIG. 7H according to one embodiment of the invention. In FIG. 7K, the station code changed from 5999 to 4811. This would occur in a device in which tuning skips virtual frequency identifiers for which no mapping is stored in the device and there are currently no mapping from 5999 to 4811. If the user depresses the knob, the cursor would move to the region code as illustrated in FIG. 7L. If the rotation knob is rotated in the state shown in FIG. 7L, the region code will change (e.g., see FIG. 7M).

If a new station has been selected as part of the tuning process, then the radio will attempt to connect to the station after a certain event is detected (e.g., a preset amount of time, a button is pressed). While this is occurring, certain embodiments display status messages in the second line of the display (e.g., see FIGS. 7N and 7O). Once the station is being received, the display will change as illustrated in FIG. 7P. Note that in FIG. 7P, the cursor has disappeared and the left hand side of the first line of the display defaults to the radio station identification information (the listening mode).

If from the state shown in FIG. 7P, the cursor is moved to the format position (e.g., by depressing the rotation knob twice), the display may appear as in FIG. 7Q. If the cursor is moved to the region code field, the display may appear as in FIG. 7R.

As previously described, the preset buttons are used to select pre-stored virtual frequency identifiers. The preset buttons can also be used to store a new preset in a manner similar to the method employed in car radios. To select a particular pre-stored virtual frequency identifier, a preset button is pressed then released. If the button has not been released, within 3 seconds, it shall be assumed that the user is attempting to store a preset value as the currently displayed virtual frequency identifier. At this time, the virtual frequency identifier to the corresponding preset location is stored in nonvolatile memory for later retrieval. If the release occurs within approximately 3 seconds, it is assumed that the user wishes to listen to the pre-stored virtual frequency identifier. The module reads the pre-stored virtual frequency identifier from the memory. Alternative embodiments could use other mechanisms know in the art to accomplish the programming of the preset buttons.

The setup mode allows the user to set or review a variety of radio operating parameters. In one embodiment, these parameters include phone numbers, account names and passwords, modes of operation and preferences. To enter setup mode, the user presses and releases the SETUP pushbutton switch. The radio will then respond with a string of data to be displayed on the second line of the display.

FIGS. 8A-8F illustrate exemplary contents of the display in setup mode. FIG. 8A illustrates exemplary contents just after pressing SETUP. In one embodiment, the user rotates the knob to go through the list of setup options. Once a particular setup option has been reached, the user may select that parameter for editing by momentarily pressing the tuning knob. The displayed setup parameter is then copied to the top line and the current value for the parameter is displayed on the second line in edit mode. (See FIG. 8B.) Note that in FIG. 8B the cursor is now turned on and shown under the character to be edited. If the current character is correct, the user may simply press the tuning knob to advance to the next character. (See FIG. 8C.) Once the cursor is in the desired position, rotation of the knob will cause the device to cycle through all the allowable characters for the setup parameter. For this case, the allowable characters are 0 to 9, SPACE and period (.). When the user has completed the editing process, the PRESET5(ENTER) button is pressed. In one embodiment, the radio is responsible for validating the value and transmitting either a confirmation, or an error code. If the confirmation indicates an error, the error message shall be blinked upon line 1 for approx. 3 seconds. (See FIG. 8D.) Note that in FIG. 8D the user mistakenly entered 192.368.1.2 which is indeed an invalid IP address (each value must be less than 256). After 3 seconds, the original line 1 data is restored and the display reverts to edit mode. (See FIG. 8E.) If the confirmation indicates success, the setup parameter name is copied back to the second line to display. (See FIG. 8F.)

Although the invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An apparatus comprising:
a dedicated internet radio device including,
a display to display a currently selected one of a plurality of virtual frequency identifiers in a fixed number of display positions,
a memory to store said plurality of virtual frequency identifiers, each of said plurality of virtual frequency identifiers including a fixed number of fields that encode with an integer value a different identifying attribute of internet radio stations, wherein the sizes of at least some of said fields vary between different ones of said plurality of virtual frequency identifiers;
a selector; and
a processor coupled to said display, said memory, and said selector to select different ones of said plurality of virtual frequency identifiers as said currently selected virtual frequency identifier.

2. The apparatus of claim 1 wherein each of said fields is independently alterable to perform said selection.

3. The apparatus of claim 1 wherein said fixed number of fields includes a region code field and a format code field that respectively encode different geographic regions and different radio station formats, and wherein said fixed number of fields also includes a station code field that encodes different internet radio stations within each of said different geographic regions and radio station formats.

4. The apparatus of claim 3 wherein:
said display includes a first line to display said currently selected virtual frequency identifier and one of the name of the geographic region, the name of the radio station format, or radio station identification information of said currently selected virtual frequency identifier.

5. The apparatus of claim 4 wherein:
each of said fields of said currently selected virtual frequency identifiers is independently changeable to perform said selection; and
said display to display the one of the name of the geographic region, the name of the radio station format, and the ration station identification information of the field currently selected for changing.

6. The apparatus of claim 4 wherein said display includes a second line to selectively display one of a location name and a radio station description of said radio station identified by said currently selected virtual frequency identifier.

7. The apparatus of claim 4 wherein said display includes a second line to selectively display one of an artist name and a song title of the currently playing song.

8. The apparatus of claim 1, wherein the display is a non-graphical alphanumeric display.

9. An apparatus comprising:
a dedicated internet radio device including,
a display to display a currently selected one of a plurality virtual frequency identifiers in a fixed number of display positions;
a database to store said plurality of virtual frequency identifiers each including a region code field, a format code field, and a station code field that collectively fit within said fixed number, and wherein the size of said fields vary between certain ones said plurality of virtual frequency identifiers;
a selector; and
a processor coupled to said display, said database, and said selector to select different ones of said plurality of virtual frequencies as said currently selected virtual frequency identifier.

10. The apparatus of claim 9, wherein different ones of said plurality of virtual frequency identifiers have different sizes of said fields but total field contents of any given one of said plurality of virtual frequency identifiers does not exceed said fixed number of display positions.

11. The apparatus of claim 9, wherein the contents of said region code field drives the size of said fields.

12. The apparatus of claim 9, wherein each of said fields is independently alterable to perform said selection.

13. The apparatus of claim 12, wherein the contents of said region field for different ones of said plurality of virtual frequencies identifies are on a per country basis.

14. The apparatus of claim 13, wherein said dedicated internet radio device further comprises:
names of said countries, wherein said display is also to display the name of said country corresponding to said currently selected virtual frequency identifier when said region code is being changed as part of said selection.

15. The apparatus of claim 14, wherein said dedicated internet radio device further comprises:
names of a plurality of predefined radio station formats, wherein the contents of said format code fields identify different ones of said plurality of predefined radio station formats; and
wherein said display is also to display the name of said radio station format corresponding to said currently selected virtual frequency identifier when said format code is being changed as part of said selection.

16. The apparatus of claim 9, wherein said dedicated internet radio device further comprises:
radio station identification information of radio stations, wherein the contents of said station code fields identify different radio stations; and
wherein said display is also to display the radio station identification information for said radio station corresponding to said currently selected virtual frequency identifier when said station code is being changed as part of said selection.

17. The apparatus of claim 16, wherein said dedicated internet radio device further comprises:
names of countries and names of a plurality of predefined radio station formats, the contents of said region field for different ones of said plurality of virtual frequencies identify different ones of said countries, the contents of said format code fields identify different ones of said plurality of predefined radio station formats; and
wherein said display is also to display the name of said country corresponding to said currently selected virtual frequency identifier when said region code is being changed as part of said selection, said display is also to display the name of said radio station format corresponding to said currently selected virtual frequency identifier when said format code is being changed as part of said selection.

18. The apparatus of claim 9 wherein said region code field and said format code field respectively encode different geographic regions and different radio station formats, and wherein said station code field encodes different internet radio stations within each of said different geographic regions and radio station formats.

19. The apparatus of claim 18 wherein:
said display includes a first line to display said currently selected virtual frequency identifier and one of the name of the geographic region, the name of the radio station format, or radio station identification information of said currently selected virtual frequency identifier.

20. The apparatus of claim 19 wherein:
each of said fields of said currently selected virtual frequency identifiers is independently changeable to perform said selection; and
said display to display the one of the name of the geographic region, the name of the radio station format, and the ration station identification information of the field currently selected for changing.

21. The apparatus of claim 19 wherein said display includes a second line to selectively display one of a location name and a radio station description of said radio station identified by said currently selected virtual frequency identifier.

22. The apparatus of claim 19 wherein said display includes a second line to selectively display one of an artist name and a song title of the currently playing song.

23. The apparatus of claim 9, wherein the plurality of virtual frequency identifiers are integers.

24. The apparatus of claim 9, wherein the display is a non-graphical alphanumeric display.

25. An electronic chip comprising:
a processor to be coupled to a display and a selector to select different ones of a plurality of virtual frequency identifiers as a currently selected virtual frequency identifier, each of said plurality of virtual frequency identifiers including a fixed number of fields that encode with an integer value a different identifying attribute of internet radio stations, wherein the sizes of at least some of said fields vary between different ones of said plurality of virtual frequency identifiers but all of said plurality of virtual frequency identifiers can individually be displayed within the same number of integer digits.
a storage device, coupled to the processor, to store one or more streaming audio players and a table of one or more mappings of said plurality of virtual frequency identifiers to URLs; and
an internet network interface, coupled to the processor, to transmit and receive data via the internet.

26. The electronic chip of claim 25 wherein each of said fields is independently alterable to perform said selection.

27. The electronic chip of claim 26 wherein said fixed number of fields includes a region code field and a format code field that respectively encode different geographic regions and different radio station formats, and wherein said fixed number of fields also includes a station code field that encodes different internet radio stations within each of said different geographic regions and radio station formats.

28. A machine-readable medium that provides instructions, which when executed by a set of one or more processors, cause said set of processors to perform operations comprising:
responsive to input, selecting one of a plurality of virtual frequency identifiers as a currently selected virtual frequency identifier, each of said plurality of virtual frequency identifiers including a fixed number of fields that encode with an integer value a different identifying attributes of internet radio stations, wherein the sizes of at least some of said fields vary between different ones of said plurality of virtual frequency identifiers but each of said plurality of virtual frequency identifiers can be displayed within the same number of digits;
displaying the currently selected virtual frequency identifier;
accessing a corresponding URL for said currently selected virtual frequency identifier; and
playing an audio stream from said URL.

29. The machine-readable medium of claim 28 wherein said selecting includes:
independently altering at least one of said fields.

30. The machine-readable medium of claim 28, wherein said fixed number of fields includes a region code field and a format code field that respectively encode different geographic regions and different radio station formats, and wherein said fixed number of fields also includes a station code field that encodes different internet radio stations within each of said different geographic regions and radio station formats.

31. The machine-readable medium of claim 30, wherein said displaying includes:
displaying on a first line of a display said currently selected virtual frequency identifier and one of the name of the geographic region, the name of the radio station format, or radio station identification information of said currently selected virtual frequency identifier.

32. The machine-readable medium of claim 30, wherein:
each of said fields of said currently selected virtual frequency identifiers is independently changeable to perform said selection; and
said displaying includes displaying on a first line of a display the one of the name of the geographic region, the name of the radio station format, and the ration station identification information of the field currently selected for changing.

33. The machine-readable medium of claim 32 wherein said displaying includes:
displaying on a second line of said display one of a location name and a radio station description of said radio station identified by said currently selected virtual frequency identifier.

34. The machine-readable medium of claim 32 wherein said displaying includes:
displaying on a second line of said display one an artist name and a song title of the currently playing song.
